(19) United States
(12) Patent Application Publication
(10) Pub. No.: US 2018/0345728 A1
(43) Pub. Date: Dec. 6, 2018

(54) Pneumatic Tire

(71) Applicants: The Yokohama Rubber Co., LTD., Minato-ku, Tokyo (JP); Kumho Tire Co., Inc., Gwangsan-gu, Gwangju (KR)

(72) Inventors: Hiroshi Hata, Hiratsuka-shi, Kanagawa (JP); Jun Matsuda, Hiratsuka-shi, Kanagawa (JP); Kee Woon Kim, Gwangsan-gu, Gwangju (KR); Chang Jung Park, Gwangsan-gu, Gwangju (KR)

(73) Assignees: The Yokohama Rubber Co., LTD., Minato-ku, Tokyo (JP); Kumho Tire Co., Inc., Gwangsan-gu, Gwangju (KR)

(21) Appl. No.: 15/777,901

(22) PCT Filed: Nov. 25, 2015
(86) PCT No.: PCT/JP2015/082993

§ 371 Date: May 21, 2018

(51) Int. Cl. B60C 11/01; B60C 13/00

(52) U.S. Cl. CPC B60C 11/01; B60C 13/00

(57) ABSTRACT

A pneumatic tire comprises a lug groove disposed outermost in a tire lateral direction in a tread portion, the lug groove opening outward in the tire lateral direction; a projection portion disposed outward of an opening portion of the lug groove in the tire lateral direction, the projection portion extending outward in a tire radial direction past a groove bottom of the lug groove at maximum groove depth and comprising an end disposed inward of a road contact surface of the tread portion in the tire radial direction, when the pneumatic tire is mounted on a regular rim, inflated to a regular internal pressure, and loaded with 70% of a regular load; and a reinforcing portion projecting from a surface of the projection portion.

### TECHNICAL FIELD

The present technology relates to a pneumatic tire that reduces vehicle external noise.

### BACKGROUND ART

In the related art, pneumatic tires designed to reduce vehicle external noise have been proposed. For example, a pneumatic tire described in Japanese Patent Publication No. 2012-096776 includes a lug groove that opens outward in a tire lateral direction on an outermost side of a tread portion in the tire lateral direction, and a projection portion disposed outward of the opening portion of the lug groove in the tire lateral direction. According to this pneumatic tire, by the projection portion being located at the outer opening portion of the lug groove in the tire lateral direction, when a vehicle on which the pneumatic tire is mounted travels, the sound produced by air column resonance is prevented from being emitted outward from the lug groove in the tire lateral direction. As a result, vehicle external noise can be reduced.

Additionally, for example, a pneumatic tire described in Japanese Patent Publication No. 2012-006483 includes a projection portion on an outer surface of a buttress portion that projects outward in a tire radial direction and continuously extends in a tire circumferential direction.

In Japanese Patent Publication Nos. 2012-096776 and 2012-006483 described above, the projection portion blocks the emission of noise outward in the tire lateral direction. However, the projection portion deforms outward in the tire lateral direction when the pneumatic tire coming into contact with ground deforms while rolling. This reduces a noise shielding effect and a vehicle external noise reduction effect, and the vehicle external noise reduction effect may be unable to be obtained.

### SUMMARY

The present technology provides a pneumatic tire that can ensure the vehicle external noise reduction effect.

A pneumatic tire according to an embodiment of the present technology includes:

a lug groove disposed outermost in a tire lateral direction in a tread portion, the lug groove opening outward in the tire lateral direction;

a projection portion disposed outward of an opening portion of the lug groove in the tire lateral direction, the projection portion extending outward in a tire radial direction past a groove bottom of the lug groove at maximum groove depth in a meridian cross-section and including an end disposed inward of a road contact surface of the tread portion in the tire radial direction, when the pneumatic tire is mounted on a regular rim, inflated to a regular internal pressure, and loaded with 70% of a regular load; and

a reinforcing portion projecting from a surface of the projection portion.

According to the pneumatic tire, the reinforcing portion projecting from the surface of the projection portion suppresses deformation of the projection portion. As a result, the projection portion can be prevented from deforming outward in the tire lateral direction when the pneumatic tire coming into contact with ground deforms while rolling, and an intrinsic noise shielding effect of the projection portion can be obtained. This allows a vehicle exterior noise reduction effect to be ensured.

In a pneumatic tire according to an embodiment of the present technology, the reinforcing portion is provided in a range from 10% to 100% of an extension height H of the projection portion in a meridian cross-section.

According to the pneumatic tire, by the reinforcing portion being provided in a range from 10% to 100% of the extension height H of the projection portion, the projection portion deforming outward in the tire lateral direction is suppressed and the noise shielding effect of the projection portion can be ensured. When the range of the reinforcing portion is less than 10% of the extension height H, the effect of suppressing the deformation of the projection portion is reduced. On the other hard, when the range of the reinforcing portion is greater than 100% of the extension height H of the projection portion, little effect beyond that when the range is 100% can be expected and the weight of the projection portion is increased.

In a pneumatic tire according to an embodiment of the present technology, the reinforcing portion includes an outer surface projecting from the surface of the projection portion with a form that is parallel with a center straight line of the projection portion in a meridian cross-section or a form that approaches the center straight line of the projection portion toward an end of the projection portion.

For example, in an embodiment in which the outer surface of the reinforcing portion that projects from the surface of the projection portion has a shape that separates away from the center straight line of the projection portion from the base end toward the end, the end side of the projection portion is heavy, and due to the centrifugal force when the pneumatic tire is rolling, the effect of suppressing deformation of the projection portion outward in the tire lateral direction is hard to obtain. Thus, the outer surface of the reinforcing portion projecting from the surface of the projection portion preferably has a form that is parallel with the center straight line of the projection portion or a form that approaches the center straight line of the projection portion toward the end of the projection portion.

In a pneumatic tire according to an embodiment of the present technology, a plurality of the reinforcing portions are disposed on the projection portion at intervals in a tire circumferential direction.

According to the pneumatic tire, the deformation of the projection portion outward in the tire lateral direction can be suppressed while keeping an increase in the weight of the projection portion to a minimum.

In a pneumatic tire according to an embodiment of the present technology, the plurality of reinforcing portions each have a shape in a side view that is parallel with or tapers toward the end of the projection portion.

According to the pneumatic tire, the effect of suppressing the deformation of the projection portion outward in the tire lateral direction can be significantly obtained while keeping an increase in the weight of the projection portion to a minimum. Furthermore, by the shape of the reinforcing portion in a side view from the tire lateral direction being a shape that tapers toward the end of the projection portion, an increase in weight on the end side of the projection portion can be suppressed, and the projection portion deforming outward in the tire lateral direction due to the centrifugal force when the pneumatic tire is rolling can be prevented.

In a pneumatic tire according to an embodiment of the present technology, a ratio ΣWr/Lr ranges from 10% to 80%, where Lr is a length in the tire circumferential direction joining ends of the plurality of reinforcing portions on the end side of the projection portion, and ΣWr is a sum of average widths Wr of the plurality of reinforcing portions.

According to the pneumatic tire, the effect of suppressing the deformation of the projection portion outward in the tire lateral direction can be significantly obtained while keeping an increase in the weight of the projection portion to a minimum. When ΣWr/Lr is less than 10%, the effect of suppressing the deformation of the projection portion outward in the tire lateral direction becomes difficult to obtain. When ΣWr/Lr is greater than 80%, the weight of the projection portion increases, and the projection portion may deform outward in the tire lateral direction due to the centrifugal force when the pneumatic tire is rolling. Thus, ΣWr/Lr preferably ranges from 10% to 80%.

In a pneumatic tire according to an embodiment of the present technology, the reinforcing portion is disposed outward of the projection portion in the tire lateral direction.

According to the pneumatic tire, by the reinforcing portion being disposed outward of the projection portion in the tire lateral direction, the position of a recessed portion on a mold corresponding to the reinforcing portion makes machining and cleaning of the mold easier than when the reinforcing portion is disposed inward in the tire lateral direction. This reduces the cost of manufacturing the mold and improves the maintainability of the mold.

In a pneumatic tire according to an embodiment of the present technology, the projection portion has a distance in the tire radial direction from the road contact surface of the tread portion to the end of 0.5 mm or greater, when the pneumatic tire is mounted on a regular rim, inflated to a regular internal pressure, and loaded with 70% of a regular load.

In a case where the distance in the tire radial direction between the tread portion and the end is less than 0.5 mm, when the pneumatic tire deforms when the vehicle travels, the frequency of the projection portion coming into contact with the road surface and the like is likely to increase, increasing instances of the projection portion deforming. Thus, according to the pneumatic tire, by the distance in the tire radial direction between the tread portion and the end being 0.5 mm to greater, the instances of the projection portion deforming are reduced. This allows a vehicle exterior noise reduction effect to be ensured.

In a pneumatic tire according to an embodiment of the present technology, the projection portion has an angle formed by the center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

When the angle formed by the center straight line and the tire radial direction line is greater than 15° inward in the tire lateral direction, the projection portion is susceptible to coming into contact with the tire main body, which may cause wear and chipping in the portion where contact occurs. When the angle formed by the center straight line and the tire radial direction line is greater than 45° outward in the tire lateral direction, the projection portion is disposed away from the lug groove, and a noise shielding effect is difficult to obtain. Thus, according to the pneumatic tire, by the angle θ formed by the center straight line and the tire radial direction line L ranging from 15° inward in the tire lateral direction to 45° outward in the tire lateral direction (from −15° to +45°, where inward in the tire lateral direction is minus and outward in the tire lateral direction is plus), a noise shielding effect from the projection portion can be significantly obtained.

In a pneumatic tire according to an embodiment of the present technology, a vehicle inner/outer side orientation when the pneumatic tire is mounted on a vehicle is designated, and the projection portion is at least formed on the vehicle outer side.

According to the pneumatic tire, vehicle external noise is emitted on the vehicle outer side. Thus, by forming the projection portion on at least the vehicle outer side, noise shielding can be effectively provided, and vehicle external noise can be reduced.

A pneumatic tire according to an embodiment of the present technology can ensure a vehicle exterior noise reduction effect.

### BRIEF DESCRIPTION OF DRAWINGS

FIG. 1 is a meridian cross-sectional view of a pneumatic tire according to an embodiment of the present technology.

FIG. 2 is a meridian cross-sectional view of a pneumatic tire according to an embodiment of the present technology.

FIG. 3 is an enlarged view of a main portion of the pneumatic tire illustrated in FIGS. 1 and 2.

FIG. 4 is an enlarged view of a main portion of the pneumatic tire illustrated in FIGS. 1 and 2.

FIG. 5 is a side view of a projection portion as viewed from the tire lateral direction.

FIG. 6 is a side view of a projection portion as viewed from the tire lateral direction.

FIG. 7 is a side view of a projection portion as viewed from the tire lateral direction.

FIG. 8 is a side view of a projection portion as viewed from the tire lateral direction.

FIG. 9 is a cross-sectional view of a portion of a projection portion as viewed from the tire lateral direction.

FIG. 10 is a cross-sectional view of a portion of a projection portion as viewed from the tire lateral direction.

FIG. 11 is a cross-sectional view of a portion of a projection portion as viewed from the tire lateral direction.

FIG. 12 is a cross-sectional view of a portion of a projection portion as viewed from the tire lateral direction.

FIG. 13 is a cross-sectional view of a portion of a projection portion as viewed from the tire lateral direction.

FIG. 14 is a cross-sectional view of a portion of a projection portion as viewed from the tire lateral direction.

FIG. 15 is a cross-sectional view of a portion of a projection portion as viewed from the tire lateral direction.

FIG. 16 is an enlarged cross-sectional view of a main portion of another example of a pneumatic tire according to an embodiment of the present technology.

FIG. 17 is a partial perspective view of the example of the pneumatic tire illustrated in FIG. 16.

FIG. 18 is a table showing the results of performance tests of pneumatic tires according to examples of the present technology.

FIG. 19 is a table showing the results of performance tests of pneumatic tires according to examples of the present technology.

### DETAILED DESCRIPTION

Embodiments of the present technology are described in detail below with reference to the drawings. However, the present technology is not limited by the embodiments. Constituents of the embodiments include elements that can be easily replaced by those skilled in the art, and elements substantially the same as the constituents of the embodiments. Furthermore, the modified examples described in the embodiments can be combined as desired within the scope apparent to those skilled in the art.

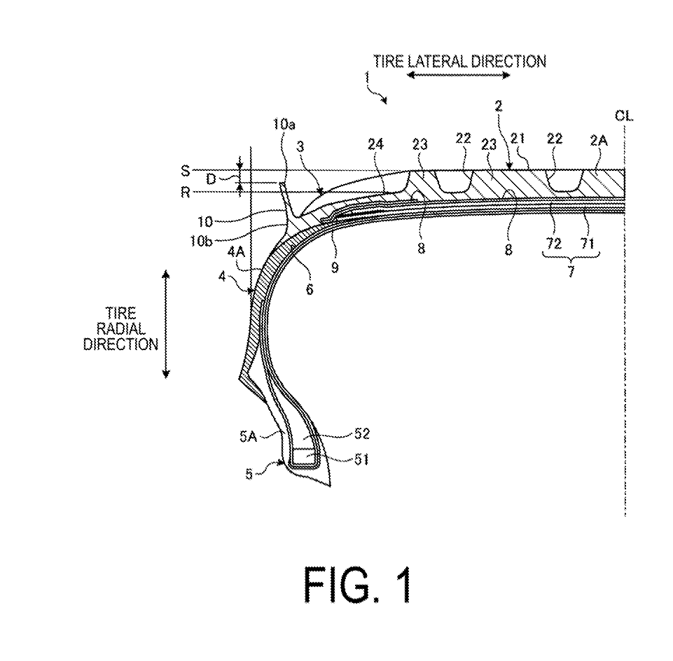

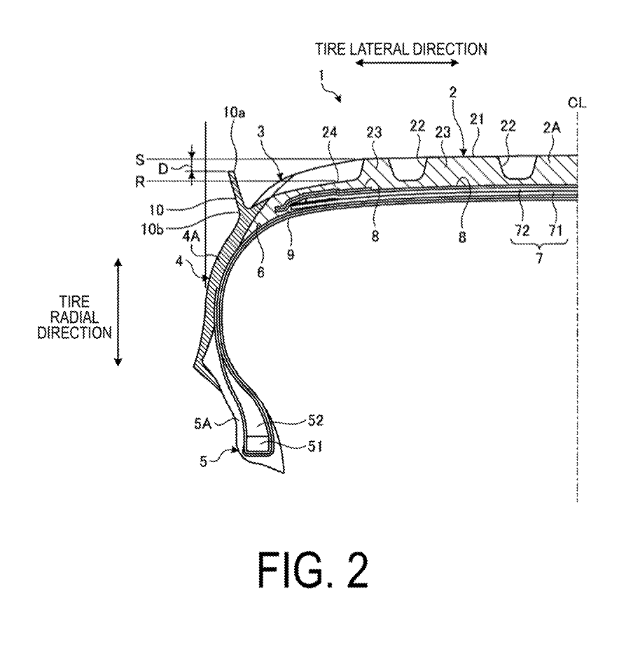

FIGS. 1 and 2 are meridian cross-sectional views of a pneumatic tire according to the present embodiment.

Herein, “tire radial direction” refers to the direction orthogonal to a rotation axis (not illustrated) of a pneumatic tire 1. “Inward in the tire radial direction” refers to the direction toward the rotation axis in the tire radial direction. “Outward in the tire radial direction” refers to the direction away from the rotation axis in the tire radial direction. “Tire circumferential direction” refers to the circumferential direction with the rotation axis as the center axis. Additionally, “tire lateral direction” refers to the direction parallel with the rotation axis. “Inward in the tire lateral direction” refers to the direction toward a tire equatorial plane CL (tire equator line) in the tire lateral direction. “Outward in the tire lateral direction” refers to the direction away from the tire equatorial plane CL in the tire lateral direction. “Tire equatorial plane CL” refers to the plane orthogonal to the rotation axis of the pneumatic tire 1 that passes through the center of the tire width of the pneumatic tire 1. “Tire width” is the width in the tire lateral direction between components located outward in the tire lateral direction, or in other words, the distance between the components that are the most distant from the tire equatorial plane CL in the tire lateral direction. “Tire equator line” refers to the line along the tire circumferential direction of the pneumatic tire 1 that lies on the tire equatorial plane CL. In the present embodiment, the tire equator line and the tire equatorial plane are denoted by the same reference sign CL. Note that the pneumatic tire 1 described below has a configuration which is essentially symmetrical about the tire equatorial plane CL. Thus for the sake of description, the pneumatic tire 1 is illustrated in a meridian cross-sectional view (FIGS. 1 and 2) and described in reference to the configuration on only one side (the right side in FIGS. 1 and 2) of the tire equatorial plane CL. A description of the other side (left side in FIGS. 1 and 2) is omitted.

As illustrated in FIGS. 1 and 2, the pneumatic tire 1 of the present embodiment includes a tread portion 2, shoulder portions 3 on both sides of the tread portion 2, and sidewall portions 4 and bead portions 5 continuing in that order from the shoulder portions 3. The pneumatic tire 1 also includes a carcass layer 6, a belt layer 7, a belt reinforcing layer 8, and an innerliner layer 9.

The tread portion 2 is made of a tread rubber 2A, is exposed on the outermost side of the pneumatic tire 1 in the tire radial direction, and the surface thereof constitutes the contour of the pneumatic tire 1. A tread surface 21 is formed on the outer circumferential surface of the tread portion 2, in other words, on the road contact surface that comes into contact with the road surface when running. The tread surface 21 is provided with a plurality (four in the present embodiment) of main grooves 22 that are straight main grooves extending in the tire circumferential direction parallel with the tire equator line CL. Moreover, a plurality of rib-like land portions 23 that extend in the tire circumferential direction are formed in the tread surface 21 by the plurality of main grooves 22. Note that the main grooves 22 may extend in the tire circumferential direction in a bending or curving manner. Additionally, lug grooves 24 that extend in a direction that intersects the main grooves 22 are provided in the land portions 23 of the tread surface 21. In the present embodiment, the lug grooves 24 show in the outermost land portions 23 in the tire lateral direction. The lug grooves 24 may meet the main grooves 22. Alternatively, the lug grooves 24 may have at least one end that does not meet the main grooves 22 and terminates within the land portion 23. In an embodiment in which both ends of the lug grooves 24 meet the main grooves 22, the land portions 23 are formed into a plurality of block-like land portions divided in the tire circumferential direction. Note that the lug grooves 24 may extend inclined with respect to the tire circumferential direction in a bending or curving manner.

The shoulder portions 3 are portions of the tread portion 2 located outward in the tire lateral direction on both sides. In other words, the shoulder portions 3 are made of the tread rubber 2A. Additionally, the sidewall portions 4 are exposed on the outermost sides of the pneumatic tire 1 in the tire lateral direction. The sidewall portions 4 are each made of a side rubber 4A. As illustrated in FIG. 1, an outer end portion of the side rubber 4A in the tire radial direction is disposed inward of an end portion of the tread rubber 2A in the tire radial direction. An inner end portion of the side rubber 4A in the tire radial direction is disposed outward of an end portion of a rim cushion rubber 5A described below in the tire lateral direction. Additionally, as illustrated in FIG. 2, the outer end portion of the side rubber 4A in the tire radial direction may be disposed outward of the end portion of the tread rubber 2A in the tire radial direction. The bead portions 5 each include a bead core 51 and a bead filler 52. The bead core 51 is formed by winding a bead wire, which is a steel wire, into an annular shape. The bead filler 52 is a rubber material that is disposed in the space formed by an end of the carcass layer 6 in the tire lateral direction folded back at the position of the bead core 51. The bead portions 5 each include an outwardly exposed rim cushion rubber 5A that comes into contact with the rim (not illustrated). The rim cushion rubber 5A extends from the tire inner side of the bead portion 5 around the lower end portion thereof to a position (sidewall portion 4) covering the bead filler 52 on the tire outer side.

The end portions of the carcass layer 6 in the tire lateral direction are folded back around the pair of bead cores 51 from inward to outward in the tire lateral direction, and the carcass layer 6 is stretched in a toroidal shape in the tire circumferential direction to form the framework of the tire. Note that the carcass layer 6 has a configuration that is mainly continuous in a radial direction, but may include a divided portion on the inner side of the tread portion 2 in the tire radial direction. The carcass layer 6 is constituted by a plurality of carcass cords (not illustrated) covered in coating rubber and disposed in alignment at an angle with respect to the tire circumferential direction that conforms with the tire meridian direction. The carcass layer 6 is provided with at least one layer.

The belt layer 7 has a multilayer structure in which at least two belts 71 and 72 are layered. In the tread portion 2, the belt layer 7 is disposed outward of the carcass layer 6 in the tire radial direction, i.e. on the outer circumference thereof, and covers the carcass layer 6 in the tire circumferential direction. The belts 71 and 72 each include a plurality of cords (not illustrated) covered in coating rubber and disposed in alignment at a predetermined angle with respect to the tire circumferential direction (for example, from 20 degrees to 30 degrees). Moreover, the belts 71 and 72 overlap each other and are disposed so that the direction of the cords of the respective belts intersect each other.

The belt reinforcing layer 8 may be provided for support as necessary. The belt reinforcing layer 8 is disposed outward of the belt layer 7 in the tire radial direction, i.e. on the outer circumference thereof, and covers the belt layer 7 in the tire circumferential direction. The belt reinforcing layer 8 includes a plurality of cords (not illustrated) coated in coating rubber and disposed in alignment in the tire lateral direction substantially parallel (±5 degrees) with the tire circumferential direction. The belt reinforcing layer 8 illustrated in FIGS. 1 and 2 is disposed so as to cover the entire belt layer 7 and disposed in a layered manner so as to cover end portions of the belt layer 7 in the tire lateral direction. The configuration of the belt reinforcing layer 8 is not limited to that described above. While not illustrated in the drawings, a configuration may be used in which, for example, two layers are disposed so as to cover all of the belt layer 7 or to cover only the end portions of the belt layer 7 in the tire lateral direction. Additionally, while not illustrated in the drawings, a configuration of the belt reinforcing layer 8 may be used in which, for example, one layer is disposed so as to cover all of the belt layer 7 or to cover only the end portions of the belt layer 7 in the tire lateral direction. In other words, the belt reinforcing layer 8 overlaps with at least the end portions of the belt layer 7 in the tire lateral direction. Additionally, the belt reinforcing layer 8 is constituted of a band-like strip material (having, for example, a width of 10 mm) wound in the tire circumferential direction.

The innerliner layer 9 is the tire inner surface, i.e. the inner circumferential surface of the carcass layer 6, and reaches the lower portion of the bead cores 51 of the pair of bead portions 5 at both end portions in the tire lateral direction and extends in the tire circumferential direction in a toroidal shape. The innerliner layer 9 prevents air molecules from escaping from the tire.

The pneumatic tire 1 described above is provided with a projection portion 10 on the shoulder portion 3. The projection portion 10 is provided continuously in the tire circumferential direction and is disposed outward, in the tire lateral direction, of the opening portion of the outermost lug groove 24 in the tire lateral direction provided on the tread portion 2. The projection portion 10 is formed projecting outward in the tire radial direction. Additionally, the projection portion 10 in a meridian cross-section extends outward, in the tire radial direction, of a groove bottom R with the maximum groove depth of the outermost lug groove 24 in the tire lateral direction, and an end 10a of the projection portion 10 is disposed inward of the road contact surface S of the tread portion 2 in the tire radial direction, when the pneumatic tire 1 is mounted on a regular rim, inflated to a regular internal pressure, and loaded with 70% of a regular load. Note that a portion of the lug groove 24 may run into the inner surface, in the tire lateral direction, of the projection portion 10.

Here, “regular rim” refers to a “standard rim” defined by the Japan Automobile Tyre Manufacturers Association Inc. (JATMA), a “Design Rim” defined by the Tire and Rim Association, Inc. (TRA), or a “Measuring Rim” defined by the European Tyre and Rim Technical Organisation (ETRTO). “Regular internal pressure” refers to a “maximum air pressure” defined by JATMA, a maximum value given in “TIRE LOAD LIMITS AT VARIOUS COLD INFLATION PRESSURES” defined by TRA, or “INFLATION PRESSURES” defined by ETRTO. “Regular load” refers to a “maximum load capacity” defined by JATMA, a maximum value given in “TIRE LOAD LIMITS AT VARIOUS COLD INFLATION PRESSURES” defined by TRA, and a “LOAD CAPACITY” defined by ETRTO.

The road contact surface S is the surface where the tread surface 21 of the pneumatic tire 1 comes into contact with the road surface, when the pneumatic tire 1 is mounted on the regular rim, inflated to the regular internal pressure, and loaded with 70% of the regular load.

As illustrated in FIGS. 1 and 2, the projection portion 10 is integrally formed with the tread rubber 2A of the tread portion 2 or the side rubber 4A of the sidewall portion 4 described above. In the pneumatic tire 1 illustrated in FIG. 1, an outer end portion of the side rubber 4A in the tire radial direction is disposed inward of an end portion of the tread rubber 2A in the tire radial direction, and the projection portion 10 is disposed together with the outer end portion of the tread rubber 2A in the tire lateral direction. In the pneumatic tire 1 illustrated in FIG. 2, an outer end portion of the side rubber 4A in the tire radial direction is disposed outward of an end portion of the tread rubber 2A in the tire radial direction, and the projection portion 10 is disposed together with the outer end portion of the side rubber 4A in the tire radial direction.

According to this pneumatic tire 1, by the projection portion 10 being located at the outer opening portion of the lug groove 24 in the tire lateral direction, when a vehicle on which the pneumatic tire 1 is mounted travels, the sound produced by air column resonance is shielded and prevented from being emitted outward from the lug groove 24 in the tire lateral direction. As a result, vehicle external noise can be reduced.

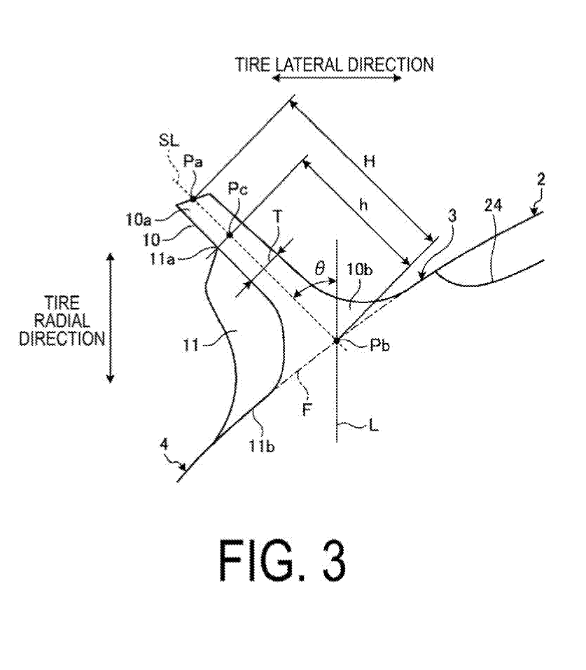

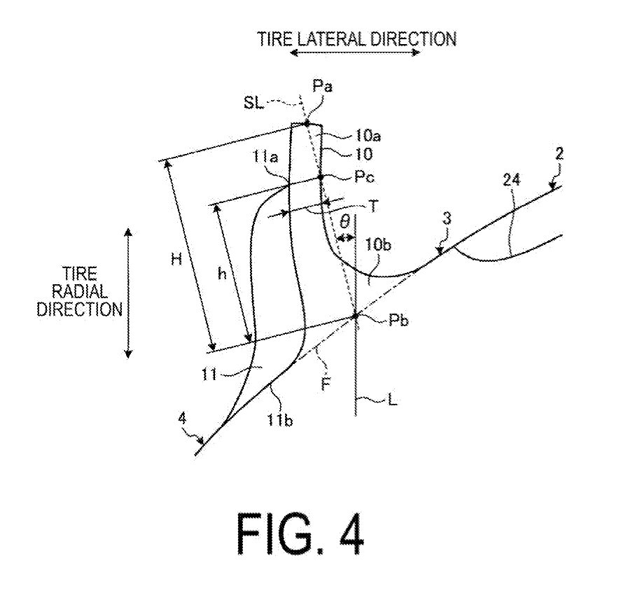

FIGS. 3 and 4 are enlarged views of a main portion of the pneumatic tire illustrated in FIGS. 1 and 2, with the projection portion 10 enlarged. As illustrated in FIGS. 3 and 4, the pneumatic tire 1 of the present embodiment includes a reinforcing portion 11 that projects from the surface of the projection portion 10.

The reinforcing portion 11 includes a portion that projects from the surface of the projection portion 10 and is made of the same or different material as the projection portion 10. The reinforcing portion 11 illustrated in FIGS. 3 and 4 is disposed outward of the projection portion 10 in the tire lateral direction, however it may be disposed inward of the projection portion 10 in the tire lateral direction, i.e., it may be disposed outward or inward in the tire lateral direction.

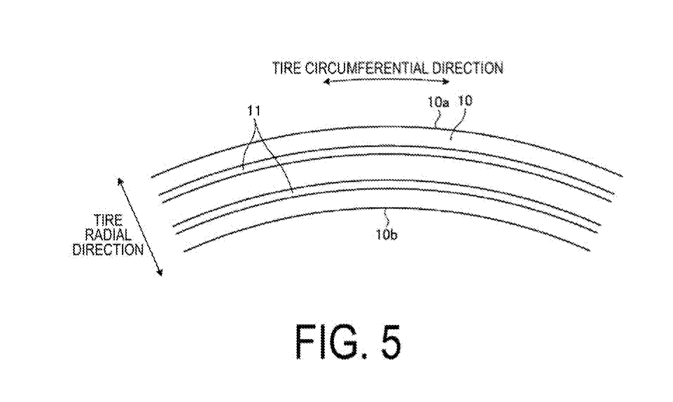

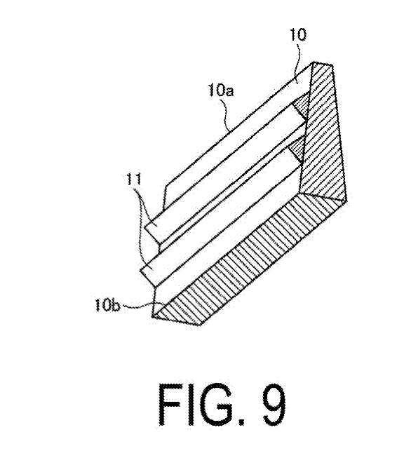

FIGS. 5 to 8 are side views of a projection portion as viewed from the tire lateral direction. FIGS. 9 to 15 are cross-sectional views of a portion of a projection portion as viewed from the tire lateral direction. As illustrated in FIGS. 5 to 15, for example, the reinforcing portion 11 is provided on the projection portion 10.

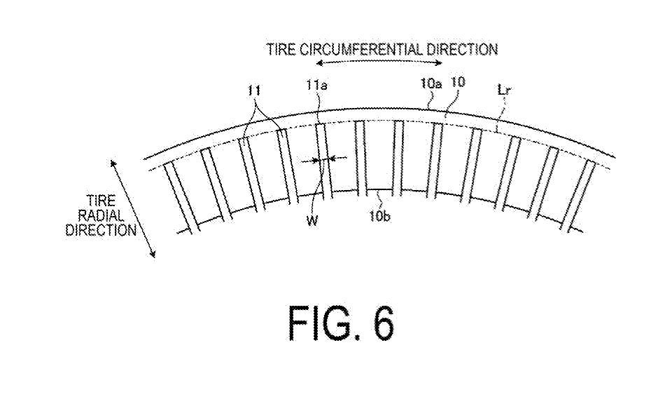

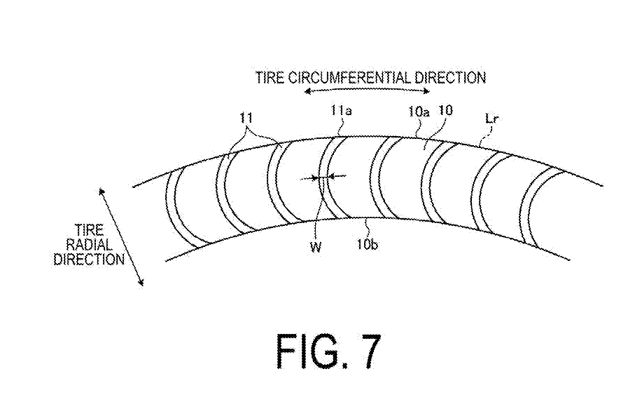

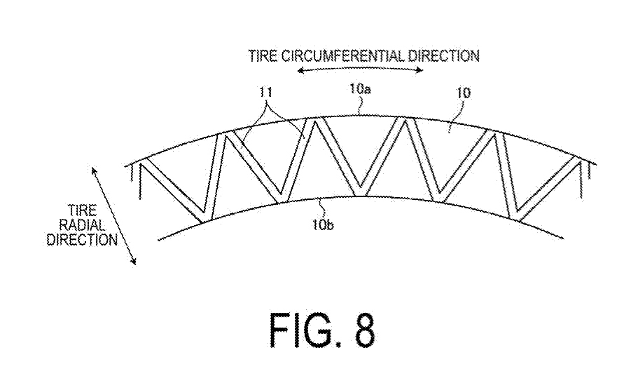

The reinforcing portion 11 illustrated in FIG. 5 includes a plurality of band-like protrusion portions disposed on the surface of the projection portion 10 in the tire lateral direction, the protrusion portions extending in the tire circumferential direction and being aligned in the tire radial direction. The reinforcing portion 11 illustrated in FIG. 6 includes a plurality of band-like protrusion portions disposed on the surface of the projection portion 10 in the tire lateral direction, the protrusion portions extending in the tire radial direction and being aligned in the tire circumferential direction. The reinforcing portion 11 illustrated in FIG. 7 includes a plurality of band-like protrusion portions disposed on the surface of the projection portion 10 in the tire lateral direction, the protrusion portions being curved in the tire radial direction and being aligned in the tire circumferential direction. The reinforcing portion 11 illustrated in FIG. 8 includes a plurality of band-like protrusion portions disposed on the surface of the projection portion 10 in the tire lateral direction, the protrusion portions being inclined in the tire radial direction, and protrusion portions adjacent to one another on an end 10a side and a base end 10b side of the projection portion 10 being connected to one another. Note that the shape of the reinforcing portion 11 is not limited to the shape described above, and may be a combined shape of any two of the shapes illustrated in FIG. 5 to 8 or may be a protrusion portion formed in a grid-like or mesh-like manner on the surface of the projection portion 10 in the tire lateral direction (not illustrated).

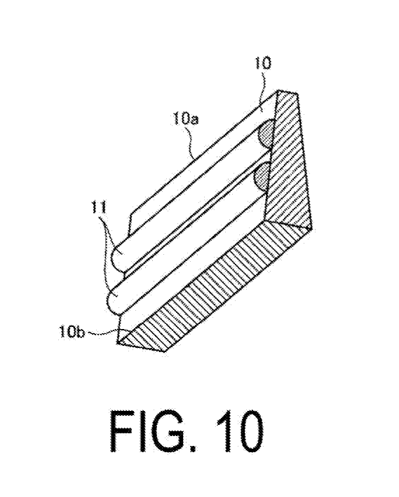

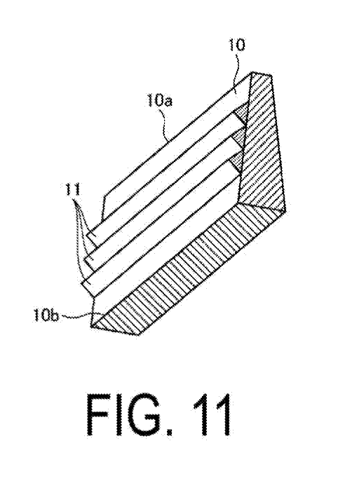

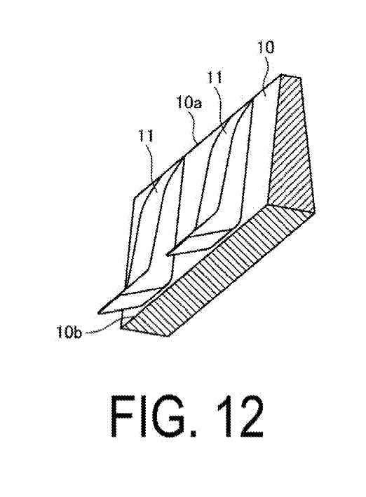

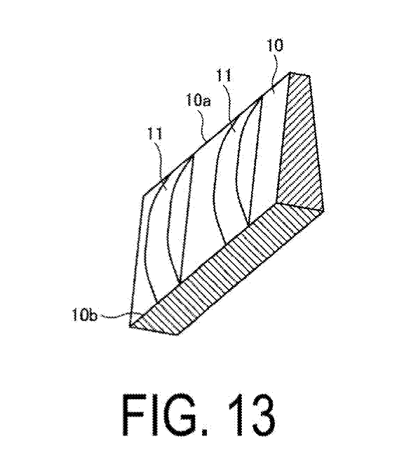

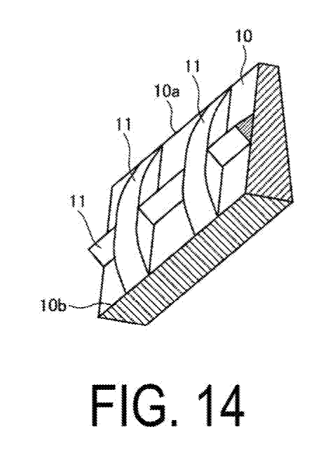

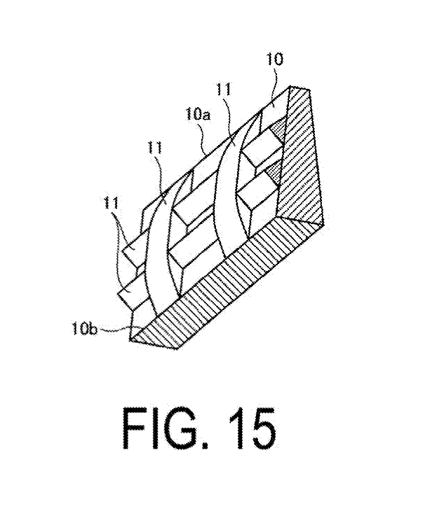

Additionally, the reinforcing portion 11 as illustrated in FIG. 5 that includes a plurality of band-like protrusion portions extending in the tire circumferential direction and aligned in the tire radial direction may, for example, be formed with a triangular cross section as illustrated in FIG. 9 or with a semi-circular cross section as illustrated in FIG. 10. Additionally, the reinforcing portion 11 as illustrated in FIG. 5 that includes a plurality of band-like protrusion portions extending in the tire circumferential direction and aligned in the tire radial direction is not, for example, limited to two bands, and three bands may be formed as illustrated in FIG. 11. The reinforcing portion 11 as illustrated in FIG. 6 that includes a plurality of band-like protrusion portions disposed on the surface of the projection portion 10 in the tire lateral direction extending in the tire radial direction and aligned in the tire circumferential direction has a shape, for example, in which the thickness projecting from the projection portion 10 gradually increases toward the base end 10b side of the projection portion 10 as illustrated in FIG. 12, or gradually decreases toward the end 10a side and the base end 10b side of the projection portion 10 as illustrated in FIG. 13. As illustrated in FIGS. 14 and 15, the shape of the reinforcing portion 11, for example, illustrated in FIG. 13 (or FIG. 12) may be combined with the shape of the reinforcing portions 11 that include a plurality of band-like protrusion portions extending in the tire circumferential direction and aligned in the tire radial direction.

In this way, the pneumatic tire includes the lug groove 24 disposed outermost in the tire lateral direction in the tread portion 2, the lug groove 24 opening outward in the tire lateral direction; the projection portion 10 disposed outward of the opening portion of the lug groove 24 in the tire lateral direction, the projection portion 10 extending outward in the tire radial direction past the groove bottom R of the lug groove 24 at maximum groove depth in a meridian cross-section and including the end 10a disposed inward of the road contact surface S of the tread portion 2 in the tire radial direction, when the pneumatic tire is mounted on a regular rim, inflated to the regular internal pressure, and loaded with 70% of a regular load; and a reinforcing portion 11 projecting from the surface of the projection portion 10.

According to the pneumatic tire 1, the reinforcing portion 11 projecting from the surface of the projection portion 10 suppresses deformation of the projection portion 10. As a result, the projection portion 10 can be prevented from deforming outward in the tire lateral direction when the pneumatic tire 1 coming into contact with ground deforms while rolling, and an intrinsic noise shielding effect of the projection portion 10 can be obtained. This allows a vehicle exterior noise reduction effect to be ensured.

As illustrated in FIGS. 3 and 4, in the pneumatic tire 1 of the present embodiment, the reinforcing portion 11 is provided in a range from 10% to 100% of an extension height H of the projection portion 10 in a meridian cross-section.

As illustrated in FIGS. 3 and 4, the extension height H of the projection portion 10 is the length, in a meridian cross-section, of a center straight line SL that joins a center point Pa of the thickness of the end 10a of the projection portion 10 and a center point Pb of the thickness of the base end 10b (an imaginary profile F of the shoulder portion 3 between the tread portion 2 and the sidewall portion 4). As illustrated in FIGS. 3 and 4, a height h, which is the range of the reinforcing portion 11, is the length of an end 11a and a base end 11b projected on the center straight line SL in a meridian cross-section. In FIGS. 3 and 4, the base end 11b of the reinforcing portion 11 is connected to the profile of the sidewall portion 4. Thus, the height h of the reinforcing portion 11 corresponds to the height from the center point Pb on the center straight line SL corresponding with the base end 11b to a point Pc where the position of the end 11a projects on the center straight line SL.

According to the pneumatic tire 1, by the reinforcing portion 11 being provided in a range from 10% to 100% of the extension height H of the projection portion 10, the projection portion 10 deforming outward in the tire lateral direction is suppressed and the noise shielding effect of the projection portion 10 can be ensured. When the range of the reinforcing portion 11 is less than 10% of the extension height H of the projection portion 10, the effect of suppressing the deformation of the projection portion 10 is reduced. When the range of the reinforcing portion 11 is greater than 100% of the extension height H of the projection portion 10, little effect beyond that when the range is 100% can be expected and the weight of the projection portion 10 is increased. Note that to significantly obtain an effect of suppressing the deformation of the projection portion 10, the range of the reinforcing portion 11 is preferably from 30% to 95% of the extension height H of the projection portion 10, and more preferably from 50% to 90%.

As illustrated in FIGS. 3 and 4, in the pneumatic tire 1 of the present embodiment, the reinforcing portion 11 preferably includes an outer surface projecting from the surface of the projection portion 10 with a form that is parallel with the center straight line SL of the projection portion 10 in a meridian cross-section or a form that approaches the center straight line SL of the projection portion 10 toward the end 10a of the projection portion 10.

The outer surface of the reinforcing portion 11 illustrated in FIGS. 3 and 4 that projects from the surface of the projection portion 10 has a shape that gradually approaches the center straight line SL of the projection portion 10 from the base end 11b toward the end 11a.

For example, in an embodiment in which the outer surface of the reinforcing portion 11 that projects from the surface of the projection portion 10 has a shape that separates away from the center straight line SL of the projection portion 10 from the base end 11b toward the end 11a, the end 10a side of the projection portion 10 is heavy, and due to the centrifugal force when the pneumatic tire 1 is rolling, an effect of suppressing deformation of the projection portion 10 outward in the tire lateral direction is hard to obtain. Thus, the outer surface of the reinforcing portion 11 projecting from the surface of the projection portion 10 preferably has a form that is parallel with the center straight line SL of the projection portion 10 or a form that approaches the center straight line SL of the projection portion 10 toward the end 10a of the projection portion 10.

As illustrated in FIGS. 3 and 4, a thickness T of the projection portion 10 is the dimension in a meridian cross-section on a line orthogonal to the center straight line SL that serves as the reference for the height H. By the thickness T of the projection portion 10 ranging from 1 mm to 15 mm at a position 50% of the height H, the inherent noise shielding effect of the projection portion 10 can be sufficiently obtained. Additionally, the outer surface of the reinforcing portion 11 projecting from the projection portion 10 preferably ranges from 1 mm to 15 mm in the direction orthogonal to the center straight line SL from the surface of the projection portion 10 (imaginary surface) to suppress deformation of the projection portion 10 outward in the tire lateral direction while keeping an increase in the weight of the projection portion 10 to a minimum.

As illustrated in FIGS. 7 and 8, in the pneumatic tire 1 of the present embodiment, a plurality of the reinforcing portions 11 are provided at intervals on the projection portion 10 in the tire circumferential direction.

According to the pneumatic tire 1, the deformation of the projection portion 10 outward in the tire lateral direction can be suppressed while keeping an increase in the weight of the projection portion 10 to a minimum.

As illustrated in FIGS. 7 and 8, in the pneumatic tire 1 of the present embodiment, in an embodiment in which a plurality of the reinforcing portions 11 are provided at intervals on the projection portion 10 in the tire circumferential direction, the shape in a side view from the tire lateral direction is preferably parallel or tapered toward the end 10a of the projection portion 10.

In other words, by the shape of the reinforcing portion 11 in a side view from the tire lateral direction being a rectangular shape such as that illustrated in FIG. 7, a trapezoidal shape, a triangular shape, or the like, the effect of effectively suppressing the deformation of the projection portion 10 outward in the tire lateral direction while keeping an increase in the weight of the projection portion 10 to a minimum can be obtained. Furthermore, by the shape of the reinforcing portion 11 in a side view from the tire lateral direction being a trapezoidal shape or a triangular shape that tapers toward the end 10a of the projection portion 10, an increase in weight on the end 10a side of the projection portion 10 can be suppressed, and the projection portion 10 deforming outward in the tire lateral direction due to the centrifugal force when the pneumatic tire 1 is rolling can be prevented.

As illustrated in FIGS. 7 and 8, in the pneumatic tire 1 of the present embodiment, in an embodiment in which a plurality of the reinforcing portions 11 are provided at intervals on the projection portion 10 in the tire circumferential direction, a ratio ΣWr/Lr preferably ranges from 10% to 80%, where Lr is the length in the tire circumferential direction joining the ends 11a of the reinforcing portions 11 on the end 10a side of the projection portion 10, and ΣWr is the sum of the average widths Wr of the reinforcing portions 11.

The average width Wr of the reinforcing portion 11 is the average of the width W. The width W is the dimension of the reinforcing portion 11 orthogonal to a tangent line in the tire circumferential direction when the projection portion 10 is viewed from the tire lateral direction.

According to the pneumatic tire 1, the effect of suppressing the deformation of the projection portion 10 outward in the tire lateral direction can be significantly obtained while keeping an increase in the weight of the projection portion 10 to a minimum. When ΣWr/Lr is less than 10%, the effect of suppressing the deformation of the projection portion 10 outward in the tire lateral direction becomes difficult to obtain. When ΣWr/Lr is greater than 80%, the weight of the projection portion 10 increases, and the projection portion 10 may deform outward in the tire lateral direction due to the centrifugal force when the pneumatic tire 1 is rolling. Thus, ΣWr/Lr preferably ranges from 10% to 80%. Note that to obtain a greater effect of suppressing the deformation of the projection portion 10 outward in the tire lateral direction while keeping an increase in the weight of the projection portion 10 to a minimum, ΣWr/Lr preferably ranges from 20% to 70%, and more preferably ranges from 30% to 70%.

Additionally, in the pneumatic tire 1 of the present embodiment, the reinforcing portion 11 is preferably disposed outward of the projection portion 10 in the tire lateral direction.

According to the pneumatic tire 1, by the reinforcing portion 11 being disposed outward of the projection portion 10 in the tire lateral direction, the position of a recessed portion on a mold corresponding to the reinforcing portion 11 makes machining and cleaning of the mold easier than when the reinforcing portion 11 is disposed inward in the tire lateral direction. This reduces the cost of manufacturing the mold and improves the maintainability of the mold.

As illustrated in FIGS. 1 and 2, in the pneumatic tire 1 of the present embodiment, in a meridian cross-section, a distance D in the tire radial direction between the road contact surface S of the tread portion 2 and the end 10a of the projection portion 10 is preferably 0.5 mm or greater when the tire is mounted on the regular rim, inflated to the regular internal pressure, and loaded with 70% of the regular load.

In a case where the distance D in the tire radial direction between the tread portion 2 and the end 10a is less than 0.5 mm, when the pneumatic tire 1 deforms when the vehicle travels, the frequency of the projection portion 10 coming into contact with the road surface and the like is likely to increase, increasing instances of the projection portion 10 deforming. Accordingly, by the distance D in the tire radial direction between the road contact surface S of the tread portion 2 and the end 10a being 0.5 mm or greater, the instances of the projection portion 10 deforming are reduced. This allows the vehicle exterior noise reduction effect to be ensured.

As illustrated in FIGS. 3 and 4, in the pneumatic tire 1 of the present embodiment, the projection portion 10 has an angle θ formed by a center straight line SL and a tire radial direction line L in a meridian cross-section preferably ranging from 15° inward in the tire lateral direction to 45° outward in the tire lateral direction when the tire is mounted on the regular rim, inflated to the regular internal pressure, and loaded with 70% of the regular load.

The angle θ ranges from −15° to +45°, where the angle θ of the tire radial direction line L is taken as 0° and tilt inward in the tire lateral direction is taken as minus and tilt outward in the tire lateral direction is taken as plus.

When the angle θ formed by the center straight line SL and the tire radial direction line L is less than −15° (larger minus angle), the projection portion 10 is disposed close to the lug groove 24, making a noise shielding effect difficult to obtain. On the other hand, when the angle θ formed by the center straight line SL and the tire radial direction line L is greater than +45° (larger plus angle), the projection portion 10 is susceptible to coming into contact with the tire main body, which may cause wear and chipping in the portion where contact occurs. Accordingly, by the angle θ formed by the center straight line SL and the tire radial direction line L ranging from −15° to +45°, a noise shielding effect from the projection portion 10 can be significantly obtained. Note that to more significantly obtain a noise shielding effect from the projection portion 10, the angle θ formed by the center straight line SL and the tire radial direction line L preferably ranges from −5° to +30°.

Furthermore, the pneumatic tire 1 of the present embodiment preferably has a designated vehicle inner/outer orientation when mounted on a vehicle, and the projection portion 10 is preferably formed at least on the vehicle outer side.

The designated vehicle inner/outer side orientation when the tire is mounted on a vehicle, while not illustrated in the drawings, for example, can be shown via indicators provided on the sidewall portion 4. The side facing the inner side of the vehicle when the tire is mounted on the vehicle is the “vehicle inner side”, and the side facing the outer side of the vehicle is the “vehicle outer side”. Note that the designations of the vehicle inner side and the vehicle outer side are not limited to cases where the tire 1 is mounted on a vehicle. For example, in cases when the tire is mounted on a rim, orientation of the rim with respect to the inner side and the outer side of the vehicle in the tire lateral direction is predetermined. Thus, in cases in which the pneumatic tire 1 is mounted on a rim, the orientation with respect to the vehicle inner side and the vehicle outer side in the tire lateral direction is designated.

According to the pneumatic tire 1, vehicle external noise is emitted on the vehicle outer side. Thus, by forming the projection portion 10 on at least the vehicle outer side, noise shielding can be effectively provided, and vehicle external noise can be reduced.

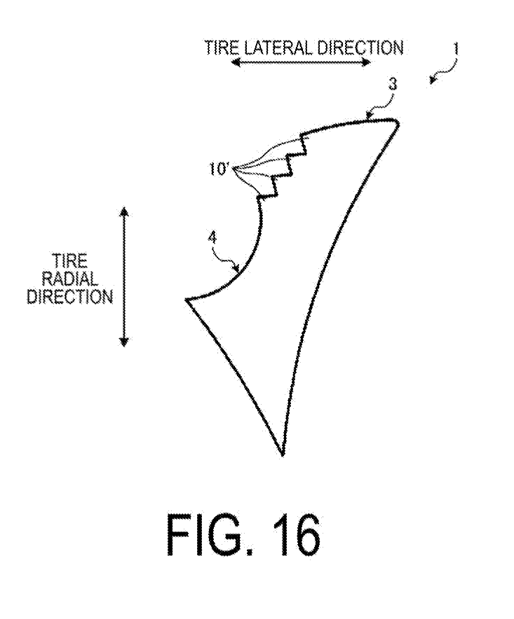

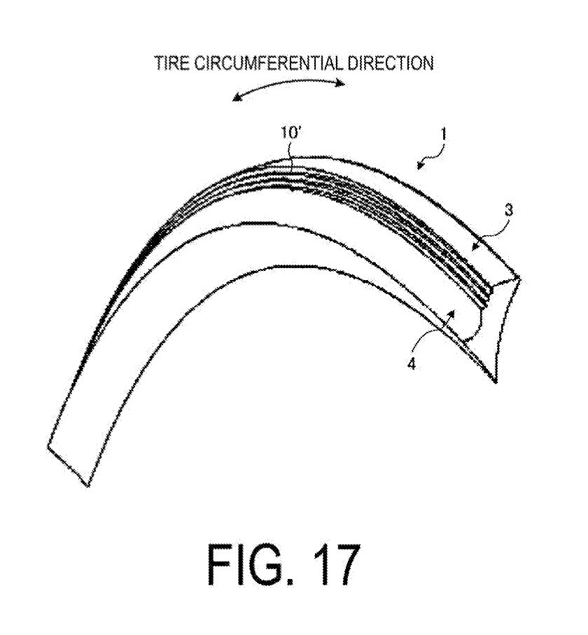

FIG. 16 is an enlarged cross-sectional view of a main portion of another example of the pneumatic tire according to the present embodiment. FIG. 17 is a partial perspective view of the example of the pneumatic tire illustrated in FIG. 16.

As illustrated in FIGS. 16 and 17, another example of the pneumatic tire 1 according to the present embodiment includes a projection portion 10′ instead of the projection portion 10 described above. The projection portion 10′ is provided continuously in the tire circumferential direction and is disposed outward, in the tire lateral direction, of the opening portion of the outermost lug groove 24 in the tire lateral direction provided on the tread portion 2. The projection portion 10′ is formed projecting outward in the tire radial direction. Additionally, a plurality (four in the present embodiment) of the projection portions 10′ are formed in the tire radial direction. In FIGS. 16 and 17, the projection portions 10′ have a triangular shape in a meridian cross-section with a V-shaped groove provided therebetween.

### EXAMPLES

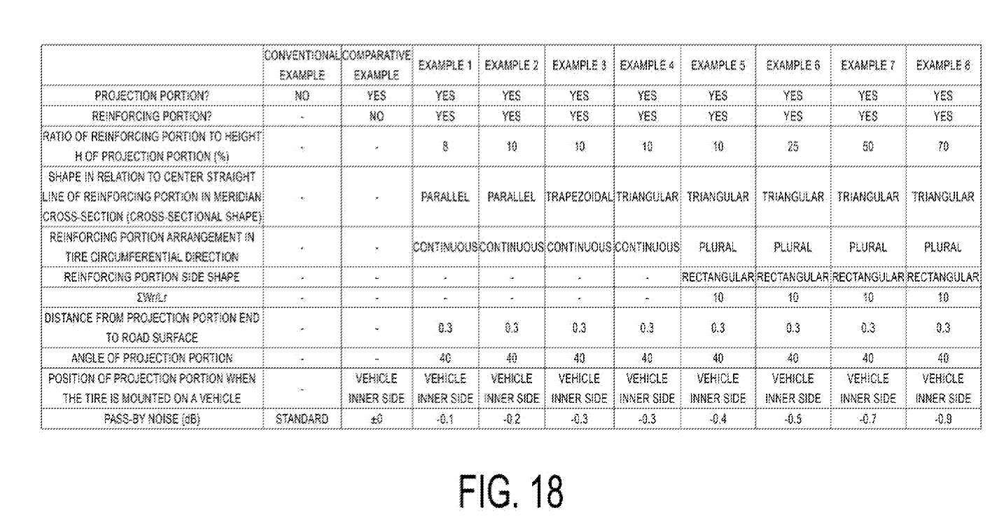

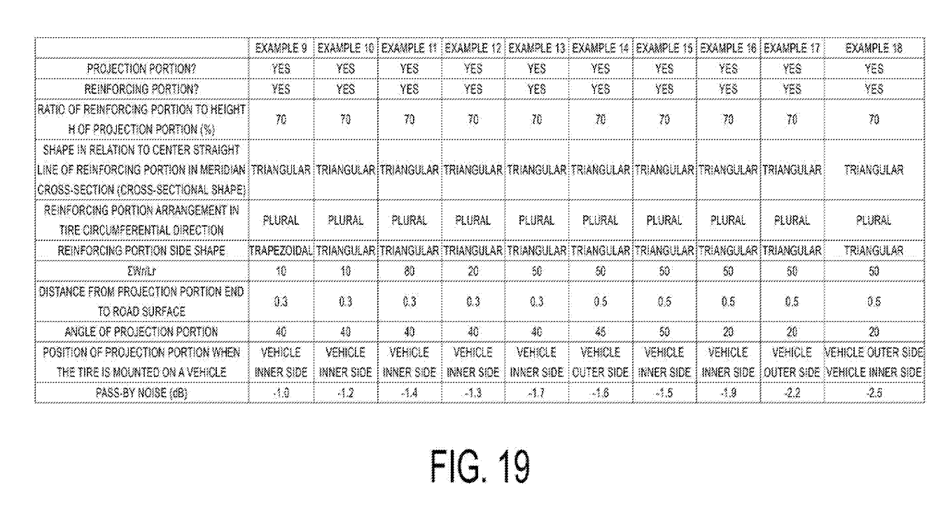

In the examples, performance tests for pass-by noise were performed on a plurality of types of pneumatic tires of different conditions (see FIGS. 18 and 19).

In the performance tests, pneumatic tires (test tires) having a tire size of 245/40R18 93W were mounted on regular rims and inflated to the regular internal pressure (250 kPa). Then, the pneumatic tires were mounted on a sedan type test vehicle having an engine displacement of 3000 cc.

In the evaluation method of pass-by noise, the magnitude of vehicle external pass-by noise was measured according to the tire noise test method specified in ECE (Economic Commission for Europe) Regulation No. 117 Revision 2 (ECE R117-02). In the test, the test vehicle was driven in a section prior to a noise measurement section, and before the noise measurement section the engine was stopped, and the test vehicle was allowed to coast in the noise measurement section where the maximum noise level dB (noise level in the frequency range of 800 Hz to 1200 Hz) was measured. This was repeated a plurality of times at a plurality of speeds, there being eight or more speeds substantially evenly divided within the range of ±10 km/h of the standard speed, and the average vehicle external pass-by noise was taken. The maximum noise level dB is the sound pressure dB (A) measured through an A characteristic frequency correction circuit using a microphone installed 7.5 m to the side of a travel center line and 1.2 m up from the road surface at a middle point in the noise measurement section. The measurement results are expressed as index values and evaluated with the conventional example being assigned as the reference (0). In the evaluation, values for the sound pressure dB less than the reference indicate low pass-by noise and superior vehicle external noise reduction performance.

The pneumatic tire of the conventional example illustrated in FIG. 18 includes no projection portions. The pneumatic tire of the comparative example includes a projection portion with the shape illustrated in FIG. 3 but no reinforcing portions. As indicated in FIGS. 18 and 19, the pneumatic tires of Examples 1 to 18 are provided with a projection portion with the shape illustrated in FIG. 3 and a reinforcing portion.

As can be seen from the test results of FIGS. 18 and 19, the pneumatic tires of Examples 1 to 18 have low pass-by noise and enhanced vehicle external noise reduction performance. Note that the angle of the projection portion is minus when tilted inward in the tire lateral direction and plus when tilted outward in the tire lateral direction.

1. A pneumatic tire, comprising:
a lug groove disposed outermost in a tire lateral direction in a tread portion, the lug groove opening outward in the tire lateral direction;
a projection portion disposed outward of an opening portion of the lug groove in the tire lateral direction, the projection portion extending outward in a tire radial direction past a groove bottom of the lug groove at maximum groove depth in a meridian cross-section and comprising an end disposed inward of a road contact surface of the tread portion in the tire radial direction, when the pneumatic tire is mounted on a regular rim, inflated to a regular internal pressure, and loaded with 70% of a regular load; and
a reinforcing portion projecting from a surface of the projection portion.

2. The pneumatic tire according to claim 1, wherein the reinforcing portion is provided in a range from 10% to 100% of an extension height H of the projection portion in a meridian cross-section.

3. The pneumatic tire according to claim 1, wherein the reinforcing portion comprises an outer surface projecting from the surface of the projection portion with a form that is parallel with a center straight line of the projection portion in a meridian cross-section or a form that approaches the center straight line of the projection portion toward an end of the projection portion.

4. The pneumatic tire according to claim 1, wherein a plurality of the reinforcing portions are disposed on the projection portion at intervals in a tire circumferential direction.

5. The pneumatic tire according to claim 4, wherein the plurality of reinforcing portions each have a shape in a side view that is parallel with or tapers toward the end of the projection portion.

6. The pneumatic tire according to claim 4, wherein a ratio ΣWr/Lr ranges from 10% to 80%, where Lr is a length in the tire circumferential direction joining ends of the plurality of reinforcing portions on the end side of the projection portion, and ΣWr is a sum of average widths Wr of the plurality of reinforcing portions.

7. The pneumatic tire according to claim 1, wherein the reinforcing portion is disposed outward of the projection portion in the tire lateral direction.

8. The pneumatic tire according to claim 1, wherein the projection portion has a distance in the tire radial direction from the road contact surface of the tread portion to the end of 0.5 mm or greater, when the pneumatic tire is mounted on a regular rim, inflated to a regular internal pressure, and loaded with 70% of a regular load.

9. The pneumatic tire according to claim 1, wherein the projection portion has an angle formed by the center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

10. The pneumatic tire according to claim 1, wherein
a vehicle inner/outer side orientation when the pneumatic tire is mounted on a vehicle is designated, and
the projection portion is at least formed on the vehicle outer side.

11. The pneumatic tire according to claim 2, wherein the reinforcing portion comprises an outer surface projecting from the surface of the projection portion with a form that is parallel with a center straight line of the projection portion in a meridian cross-section or a form that approaches the center straight line of the projection portion toward an end of the projection portion.

12. The pneumatic tire according to claim 11, wherein a plurality of the reinforcing portions are disposed on the projection portion at intervals in a tire circumferential direction.

13. The pneumatic tire according to claim 12, wherein the plurality of reinforcing portions each have a shape in a side view that is parallel with or tapers toward the end of the projection portion.

14. The pneumatic tire according to claim 13, wherein a ratio ΣWr/Lr ranges from 10% to 80%, where Lr is a length in the tire circumferential direction joining ends of the plurality of reinforcing portions on the end side of the projection portion, and ΣWr is a sum of average widths Wr of the plurality of reinforcing portions.

15. The pneumatic tire according to claim 14, wherein the reinforcing portion is disposed outward of the projection portion in the tire lateral direction.

16. The pneumatic tire according to claim 15, wherein the projection portion has a distance in the tire radial direction from the road contact surface of the tread portion to the end of 0.5 mm or greater, when the pneumatic tire is mounted on a regular rim, inflated to a regular internal pressure, and loaded with 70% of a regular load.

17. The pneumatic tire according to claim 16, wherein the projection portion has an angle formed by the center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

18. The pneumatic tire according to claim 17, wherein
a vehicle inner/outer side orientation when the pneumatic tire is mounted on a vehicle is designated, and
the projection portion is at least formed on the vehicle outer side.
